(19) United States
(12) Patent Application Publication
(10) Pub. No.: US 2013/0276738 A1
(43) Pub. Date: Oct. 24, 2013

(54) laser spark plug and method for operating same

(71) Applicant: Rene Hartke, Stuttgart (DE)

(72) Inventor: Rene Hartke, Stuttgart (DE)

(21) Appl. No.: 13/882,271

(22) PCT Filed: Sep. 8, 2011
(86) PCT No.: PCT/EP11/65564

§ 371 Date: Jul. 11, 2013

(30) Foreign Application Priority Data
Oct. 28, 2010 (DE) 10 2010 043 058.7

(51) Int. Cl. F02P 23/04

(52) U.S. Cl. CPC F02P 23/04
USPC 123/143 B; 701/102

(57) ABSTRACT

A laser spark plug for an internal combustion engine having a laser device, which includes a laser-active solid and a passive Q-switch, and having a pumped light source, which is configured to generate pumped radiation and to irradiate it onto the laser device. The pumped light source has a plurality of individual pumped light emitters at least two pumped light emitters each being activatable separately from one another.

### FIELD OF THE INVENTION

The present invention relates to a laser spark plug for an internal combustion engine having a laser device, which includes a laser-active solid and a passive Q-switch, and having a pumped light source, which is configured to generate pumped radiation and to irradiate it onto the laser device. The present invention further relates to a method for operating a laser spark plug of this type.

### BACKGROUND INFORMATION

It is already known to use passive Q-switched solid-state lasers in laser spark plugs for internal combustion engines to generate high-energy laser ignition pulses for the internal combustion engine. Known systems, however, do not allow a variable setting of the pulse energy of the generated laser ignition pulses without a mechanical movement of the optical elements situated in the laser spark plug, which requires a complex and error-prone construction.

### SUMMARY OF THE INVENTION

Accordingly, it is an object of the present invention to improve a laser spark plug and an operating method of the type mentioned at the outset in such a way that the pulse energy of the generated laser ignition pulses may be varied without having to provide movable optical components in the laser spark plug.

This object may be achieved according to the present invention in a laser spark plug of the type mentioned at the outset in that the pumped light source has a plurality of individual pumped light emitters, at least two pumped light emitters each being activatable separately from one another. With the aid of the separate activation according to the present invention of different pumped light emitters of the pumped light source of the laser spark plug, it is advantageously possible to influence the volume of the laser device or of the laser-active solid pumped optically with the aid of the pumped radiation, thus also setting the pulse energy of the generated laser ignition pulses.

For example, a greater pumped volume may be implemented in the laser device by operating multiple pumped light emitters in parallel, so that laser ignition pulses having a higher pulse energy may be generated. Insofar as laser ignition pulses having a relatively low pulse energy are to be generated, it is, for example, possible to activate only a small number or only a single pumped light emitter due to the separate activatability, whereby an accordingly reduced pumped volume results which leads to laser ignition pulses having a lower pulse energy.

In one specific embodiment, it is provided that the pumped light emitters are situated on an essentially planarly configured heat sink, whereby a simple and efficient coupling of the generated pumped radiation into the laser device and an optimal cooling of the pumped light emitters simultaneously result. Due to the planar configuration, a direct spatial equivalent of the individual pumped light emitters having corresponding areas of a beam cross section is moreover advantageously provided for the pumped radiation to be generated.

In another specific embodiment in which pumped radiation may be generated with particular flexibility with regard to a beam profile or beam cross section, it is provided that the pumped light emitters are situated essentially in a matrix-like manner, multiple rows and columns of individual pumped light emitters being provided.

In another advantageous specific embodiment, it is provided that the pumped light emitters are essentially situated along multiple virtual concentric circular ring areas, whereby circular ring radiation profiles or circular radiation profiles of different diameters are generatable particularly advantageously. In this way, a solid-state laser of the laser device, which is configured as a circular cylinder, may be particularly advantageously acted on by pumped radiation, in particular the setting of different pumped volumes being possible.

In another advantageous specific embodiment, it is provided that the pumped light emitters are essentially situated along at least one virtual spiral line, whereby a beam profile which is efficient for the optical pumping of the laser device is also achievable according to studies by the applicant.

According to another specific embodiment, it is particularly advantageous to connect multiple pumped light emitters to one another, which are situated on the same virtual circle or circular ring, to form an emitter group whose pumped light emitters are activatable together via a control connection of the emitter group. In this way, a pumped light emitter group may advantageously be defined according to the present invention, i.e., an area which emits pumped radiation and which may also have complex geometries depending on the configuration of the individual pumped light emitters and their connection to the emitter group.

The previously mentioned principle is, for example, also applicable to such pumped light emitters which are essentially situated along a virtual spiral line, multiple pumped light emitters in a predefinable longitudinal section of the spiral line possibly being interconnected to form one emitter group.

Another improved irradiation of pumped radiation into the laser device to be pumped is provided according to another advantageous specific embodiment in that individual pumped light emitters or groups of pumped light emitters are assigned to microlenses to collimate the pumped radiation.

In another particular specific embodiment, it is provided that the pumped light emitters each have at least one, or multiple, semiconductor laser(s) of the VCSEL type (vertical cavity surface emitting laser), i.e., surface emitting semiconductor lasers.

A particularly compact and fail-safe configuration results according to another specific embodiment in that the pumped light source is integrated into a housing of the laser spark plug.

The heat sink may particularly also be integrally joined to the housing of the laser spark plug. A configuration in which the heat sink and the housing of the laser spark plug form one piece is also conceivable.

The object of the present invention may also be achieved by an operating method according to the description herein. According to the operating method according to the present invention, it is proposed that the pumped light source has a plurality of individual pumped light emitters and that at least two pumped light emitters are each activated separately from one another.

A particular specific embodiment of the method according to the present invention provides that different groups of pumped light emitters are activated as a function of a pulse energy which should have a laser pulse generated by the laser device.

The definition of the pumped light emitter groups may take place in various ways. On the one hand, different individual pumped light emitters may be connected to one another to form a pumped light group which may be activated jointly. On the other hand, each individual pumped light emitter of the pumped light source may be connected to a control circuit which activates the pumped light source, so that the control circuit may directly activate the individual emitters. In this variant of the present invention, the greatest possible flexibility with regard to the generation of pumped radiation having different beam profiles is provided, since individual pumped light emitters may be selectively switched on and off (i.e., (de)activated).

To simplify the circuitry connecting the pumped light source according to the present invention to a control circuit, multiple pumped light emitters may, however, be interconnected in such a way that multiple pumped light emitter groups result which have a circular ring shape, for example, and extend radially—which may be coaxially to one another—from the inside to the outside across the pumped light source.

It is also conceivable to connect individual pumped light emitters to form pumped light emitter groups which have an essentially hexagonal structure or another type of polygonal structure. During the manufacture, such pumped light emitter groups may be combined to form more complex geometries, e.g., circular rings, etc., by being appropriately positioned on the heat sink or a carrier element.

In another advantageous specific embodiment of the method according to the present invention, it is provided that radially inner pumped light emitters are activated to generate a laser pulse having a first pulse energy, and that radially inner and radially outer pumped light emitters are activated to generate a laser pulse having a second pulse energy which is higher than the first pulse energy.

Additional features, possible applications, and advantages of the present invention are derived from the following description of exemplary embodiments of the present invention, which are illustrated in the figures of the drawing. All features described or illustrated represent the object of the present invention alone or in any arbitrary combination, regardless of their recapitulation herein or their back-references, and regardless of their wording in the description or illustration in the drawing.

### BRIEF DESCRIPTION OF THE DRAWINGS

FIG. 1 shows an internal combustion engine having a laser spark plug according to the present invention.

FIG. 2 shows in detail a first specific embodiment of the laser spark plug from FIG. 1 according to the present invention.

FIG. 3a shows a side view of a pumped light source according to one specific embodiment.

FIG. 3b shows a top view of the pumped light source according to FIG. 3a.

FIGS. 4a, 4b, 4c, 4d, and 4e each show another specific embodiment of a pumped light source according to the present invention in different operating states.

FIG. 5 shows a detailed view of a single pumped light emitter of the pumped light source according to FIG. 4a.

FIG. 6a shows a top view of a pumped light emitter according to another specific embodiment.

FIG. 6b shows a side view of a pumped light source according to another specific embodiment.

FIG. 6c shows a specific embodiment of a pumped light source having a spiral-shaped configuration of pumped light emitters.

FIG. 7 shows a side view of another specific embodiment of the laser spark plug according to the present invention.

### DETAILED DESCRIPTION

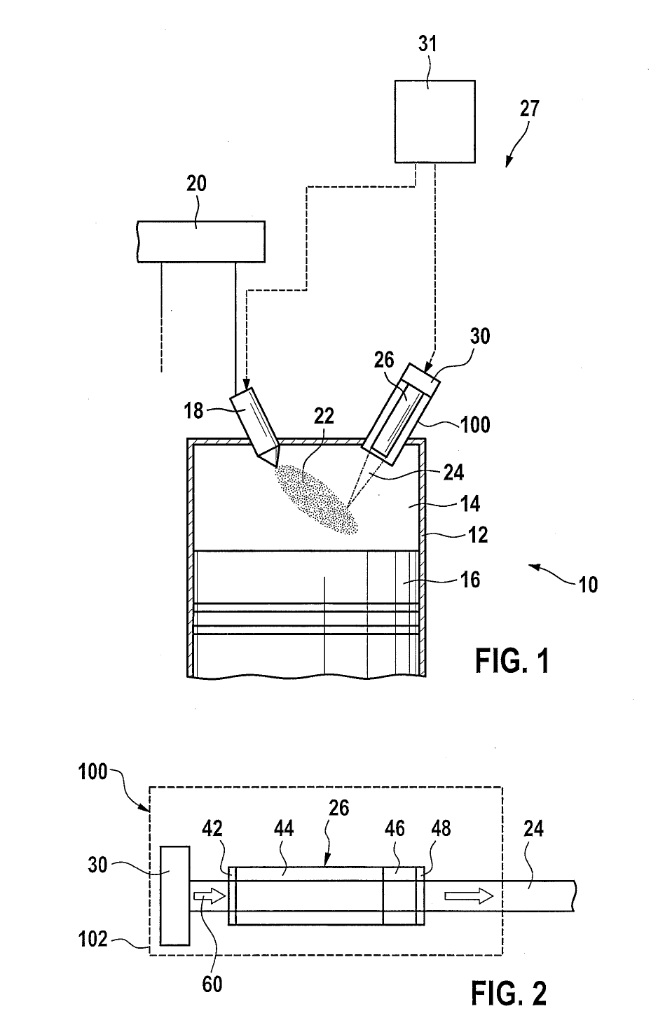

In FIG. 1, an internal combustion engine is identified as a whole by reference numeral 10. It is used for driving a motor vehicle (not illustrated). Internal combustion engine 10 includes multiple cylinders, only one of which is labeled with reference numeral 12 in FIG. 1. A combustion chamber 14 of cylinder 12 is delimited by a piston 16. Fuel enters combustion chamber 14 directly through an injector 18, which is connected to a fuel pressure accumulator 20, also referred to as a rail.

Fuel 22 injected into combustion chamber 14 is ignited with the aid of a laser beam 24 which may be emitted in the form of a laser pulse 24 into combustion chamber 14 by a laser spark plug 100 having a laser device 26. For this purpose, laser device 26 is supplied with pumped light by a pumped light source 30. Pumped light source 30 may be integrated into laser spark plug 100 and activated by a control unit 31, which also activates injector 18.

Pumped light source 30 forms in conjunction with laser spark plug 100 having laser device 26 a laser-based ignition system 27 of internal combustion engine 10.

In addition to internal combustion engines for motor vehicles, laser-based ignition system 27 may be used in stationary engines, such as heavy-duty gas engines, etc.

As is apparent from the detailed view of FIG. 2, laser device 26 also has according to the present invention a passive Q-switch 46 in addition to a laser-active solid 44, so that components 44, 46 form a passively Q-switched laser oscillator in conjunction with an input mirror 42 and an output mirror 48.

The basic functionality of laser device 26 is the following: Pumped light 60 which is supplied to laser device 26 by pumped light source 30 enters laser-active solid 44 through input mirror 42 which is transparent for a wavelength of pumped light 60. There, pumped light 60 is absorbed, which results in a population inversion. The initially high transmission losses of passive Q-switch 46 prevent a laser oscillation in laser device 26. However, the beam density inside the resonator formed by laser-active solid 44 and passive Q-switch 46 as well as mirrors 42, 48 increases with increasing pumping time. Starting from a certain beam density, passive Q-switch 46 or a saturable absorber of passive Q-switch 46 fades out so that a laser oscillation takes place in the resonator.

Due to this mechanism, which is known per se, a laser beam 24 is generated in the form of a so-called giant pulse which passes through output mirror 48 and is referred to in the following as a laser ignition pulse.

Instead of the previously described passive Q-switch 46, the use of an active Q-switch is also conceivable.

As already mentioned previously, pumped light source 30 may be situated directly in a housing 102 of laser spark plug 100, as is laser device 26.

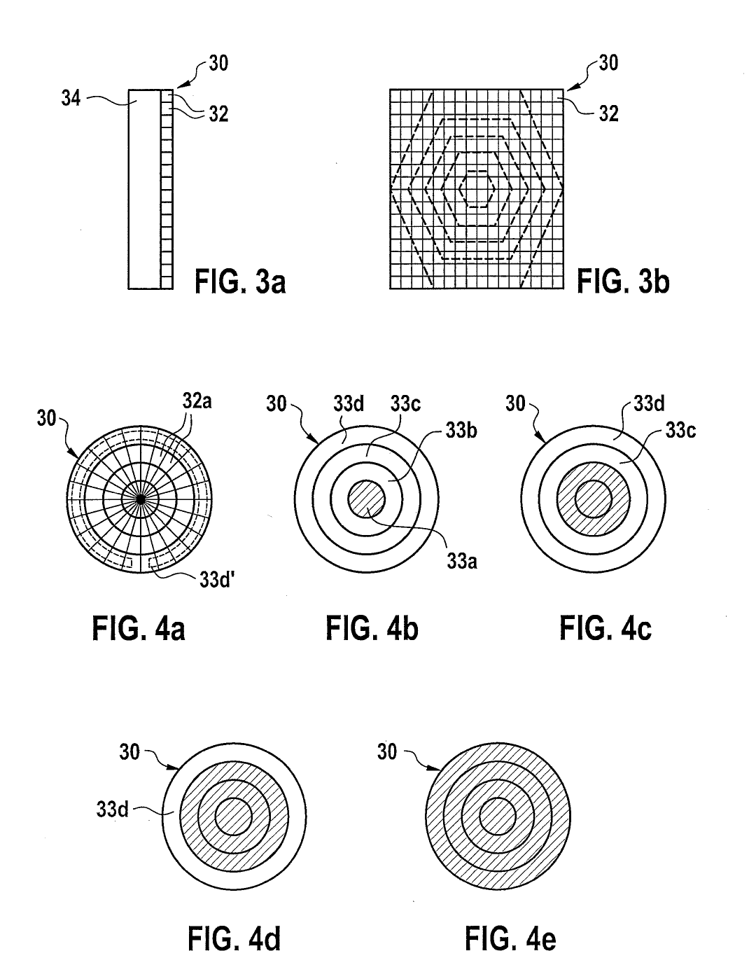

It is provided according to the present invention that pumped light source 30 has a plurality of individual pumped light emitters 32. FIG. 3a here schematically shows a side view of a specific embodiment of pumped light source 30 in which multiple individual pumped light emitters 32 are situated on an essentially planarly configured heat sink 34. Instead of a heat sink 34, another type of a carrier element may also be provided.

According to the present invention, at least two pumped light emitters 32 are each activatable separately from one another, whereby the beam profile of pumped radiation 60 generated overall by pumped light source 30 may be influenced solely by an appropriate electrical activation of individual pumped light emitters 32, in particular without movable optical components having to be provided in the beam path of pumped radiation 60.

FIG. 3b shows a top view of pumped light source 30 from FIG. 3a from which it is apparent that individual pumped light emitters 32 of pumped light source 30 are essentially matrix-shaped, i.e., are situated in multiple rows and columns and distributed over heat sink 34.

By activating individual pumped light emitters 32 or groups of pumped light emitters in a targeted manner, it is, for example, possible to implement a plurality of different beam profiles, as illustrated in FIG. 3b with the aid of the hexagons indicated by dashed lines.

For example, only a first pumped light emitter group, which is symbolized by the innermost hexagon in FIG. 3b, i.e., the four central pumped light emitters of the configuration, may be activated in a first operating mode. In this operating mode, a correspondingly small pumped volume results in laser device 44 (FIG. 2) due to the small beam cross section of pumped radiation 60, so that the pulse energy of laser pulses 24 generated by laser device 26 are also correspondingly small.

In another operating mode, pumped light source 30 may in contrast be activated in such a way that multiple pumped light emitters, which are situated radially farther outside compared to the first pumped light emitter group, are also activated (cf. the second smallest hexagon from FIG. 3b). In this operating mode, pumped radiation 60 already has a significantly larger beam cross section so that, accordingly, a larger pumped volume results in laser device 26 and thus an increased pulse energy results for generated laser pulses 24 (FIG. 1).

Other individual pumped light emitters 32, which are situated radially even farther outside, may also be connected if necessary in the sense of the previously described hexagonal configuration to enlarge the pumped volume accordingly.

In addition to an individual activation of individual pumped light emitters 32 of pumped light source 30, an electrical interconnection of individual pumped light emitter groups 32 may advantageously be provided in such a way that the beam cross sections illustrated by the different hexagons in FIG. 3b are each selectable through a single control line. For this purpose, all individual pumped light emitters 32, which are situated in the corresponding hexagonal area, are to be interconnected accordingly for a joint activation by a control electronics.

FIG. 4a shows a top view of another specific embodiment of pumped light source 30 according to the present invention in which individual pumped light emitters 32a essentially have a sector shape. Particularly, pumped light emitters 32a may be connected to one another according to another variant of the present invention in such a way that pumped light emitter groups result which may be activated together and which essentially cover a circular ring area. For example, all radially inner pumped light emitters (not identified in greater detail) may be interconnected to form a first pumped light emitter group, so that inner circular ring area 33a (FIG. 4b) is activatable separately for the generation of pumped radiation 60 having a small beam diameter (cf. hatched area of pumped light source 30 in FIG. 4b). Another circular ring area 33b may accordingly be assigned to another pumped light emitter group. FIG. 4c shows a top view of pumped light source 30 according to FIG. 4b, pumped light emitter group 33b, which has a circular ring shape and is situated radially even farther outside, being activated in addition to inner pumped light emitter group 33a (hatched area).

Accordingly, FIG. 4d illustrates the activation of pumped light source 30 while simultaneously activating first three radially inner pumped light emitter groups 33a, 33b, 33c (cf. FIG. 4b).

FIG. 4e finally shows a top view of pumped light source 30 according to FIG. 4b in which all pumped light emitter groups are activated and a maximum pumped volume accordingly results in laser device 26 (FIG. 2).

An electrical connection of radially outer pumped light emitter group 33d (FIG. 4b) is also apparent from FIG. 4a. Dashed lines 33d′ in the area of pumped light emitter group 33d symbolize a shared electrical connection of all radially outer pumped light emitters in such a way that circular ring area 33d (FIG. 4b) results. Similarly, such an electrical wiring may be provided for pumped light emitter groups 33a, 33b, 33c, which are situated radially farther inside, so that for an electrical activation, which is individual to each circular ring, of the operating states illustrated in FIGS. 4b through 4d, only four electrical control lines are to be provided and an accordingly simple wiring of pumped light source 30 to control unit 31 (FIG. 1) results.

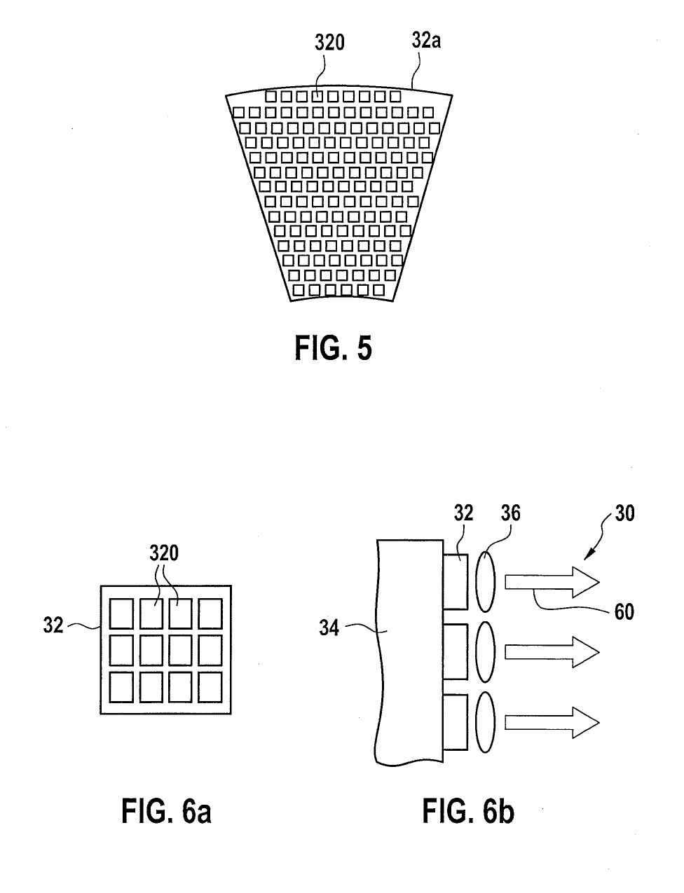

FIG. 5 shows a top view of a single pumped light emitter 32a of pumped light source 30 according to FIG. 4a. Pumped light emitter 32a essentially has a sector shape. To generate pumped radiation 60 (FIG. 2), a plurality of semiconductor lasers 320 is provided in a surface area of pumped light source 30 corresponding to pumped light emitter 32a. Semiconductor lasers 320 may be flexibly electrically switched in series or in parallel to one another (combinations are also possible), whereby a good adaptation to the electrical supply (voltage, current) may be implemented for pumped light source 30.

In one particular specific embodiment, semiconductor lasers 320 are VCSELs (vertical cavity surface emitting lasers), i.e., surface emitting semiconductor lasers. VCSELs 320 are ideally suited for a direct installation into laser spark plug 100 due to their relatively high maximum allowable operating temperature, so that in one specific embodiment, pumped light source 30 may be integrated directly into laser spark plug 100 or into its housing 102. It is furthermore advantageous that VCSELs 320 are robust with respect to back reflections of pumped radiation 60 and are not susceptible to COMD (catastrophic optical mirror damage).

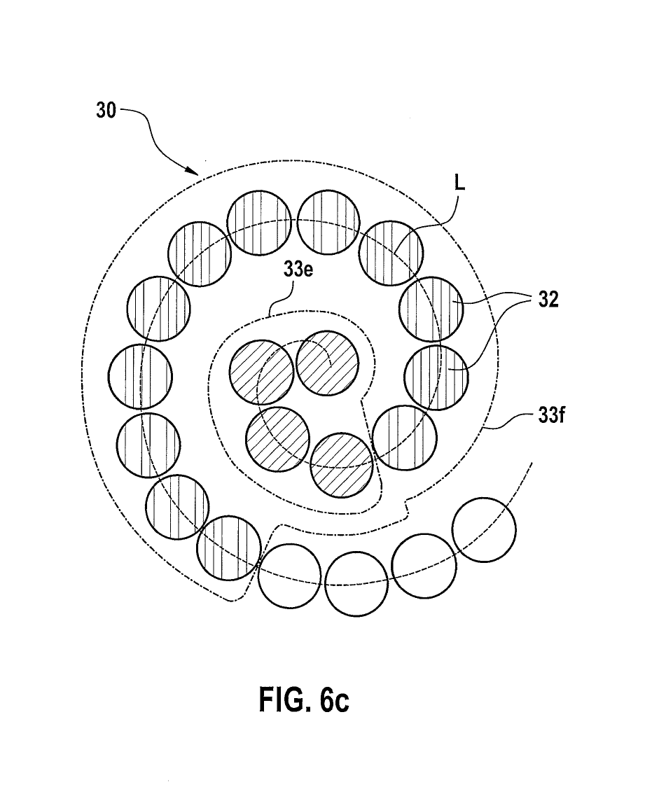

FIG. 6a shows a top view of another specific embodiment of a pumped light emitter 32 which essentially has a rectangular contour and presently has a total of twelve VCSELs 320, which in turn are situated in the shape of a matrix. Pumped light emitters 32 may be situated as a function of the geometry of laser device 26 to be pumped in almost any arbitrary way on a target structure, e.g., heat sink 34 (FIG. 3a). Multiple VCSELs 320 may be electrically connected to one another to form a pumped light emitter 32 which, in turn, may be connected to multiple pumped light emitters 32 of identical or different types to form a pumped light emitter group.

FIG. 6b schematically shows a side view of another specific embodiment of pumped light source 30 according to the present invention in which individual pumped light emitters 32 are each assigned one microlens 36 which is in particular configured to collimate the pumped radiation generated by individual pumped light emitters 32, whereby a further improved coupling of pumped radiation 60 of pumped light source 30 into laser device 26 results.

A particularly reliable heat transfer from pumped light source 30 to housing 102 (FIG. 2) of laser spark plug 100 is ensured when pumped light source 30 or its heat sink 34 is integrally joined to laser spark plug 100 or its housing 102. Heat sink 34 may also be configured in one piece with housing 102 of laser spark plug 100.

FIG. 6c schematically shows a top view of another specific embodiment of a pumped light source 30 according to the present invention. In the present case, individual pumped light emitters 32 are situated along a virtual spiral line L. The first four radially inner pumped light emitters, which are not identified in greater detail in FIG. 6c, are connected to one another in the present case and thus form a first pumped light emitter group 33e. Pumped light emitters 32, which are situated radially farther outside, are also interconnected to form a pumped light emitter group 33f. To highlight the individual pumped light emitter groups, the pumped light emitters of first pumped light emitter group 33e are identified by oblique hatching, while individual pumped light emitters 32 of second pumped light emitter group 33f are illustrated by vertical hatching.

The configuration depicted in FIG. 6c also allows different pumped light emitter groups 33e, 33f to be activated separately and thus the pumped volume of laser device 26 (FIG. 2) to be influenced.

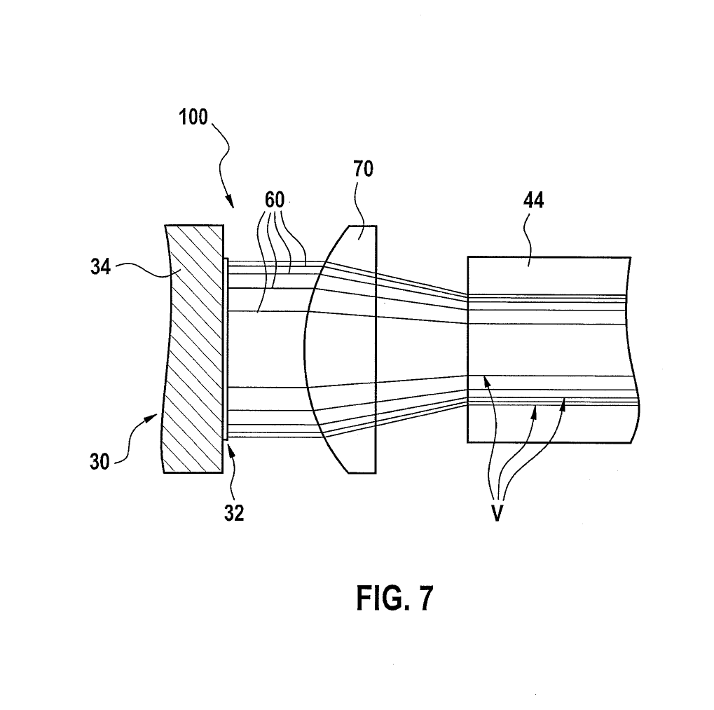

FIG. 7 schematically shows a side view of a specific embodiment of laser spark plug 100 according to the present invention in which a plurality of individual pumped light emitters 32, or of pumped light emitters 32 which are at least activatable in different pumped light emitter groups, is situated on a heat sink 34. Reference numeral 60 illustrates again the pumped radiation, such as the one generatable according to the present invention by pumped light source 30 having different beam cross sections.

Focusing lens system 70, which focuses generated pumped radiation 60 in laser-active solid 44, is situated optically downstream from pumped light source 30. Depending on the beam cross section of pumped radiation 60, a differently sized pumped volume V results in each case in the previously described manner, which results in laser ignition pulses 24 (FIG. 1) having an accordingly different pulse energy.

A first specific embodiment of the operating method according to the present invention for laser spark plug 100 may advantageously provide for the activation of multiple pumped light emitters 32 or different pumped light emitter groups 33a, 33b, . . . (FIG. 4b) separately from one another, to modify the beam profile of pumped radiation 60 in the manner described previously. In particular, different groups of pumped light emitters may be activated as a function of the pulse energy which a laser pulse 24 (FIG. 1) generated by laser device 26 should have.

Particularly, only the radially inner pumped light emitters (cf. pumped light emitter group 33a from FIG. 4b) may be activated to generate laser pulses 24 having a relatively low pulse energy, while the pumped light emitter groups, which are situated farther outside, (cf. reference numerals 33b, 33c, 33d) are additionally activated when laser pulses 24 having a higher pulse energy are to be generated.

By defining the multiple pumped light emitter groups, it may moreover be established at which granularity pumped radiation 60 may act on laser device 26. When using VCSELs 320, individual pumped light emitter groups, which have a circular ring shape, may particularly be connected to one another. These pumped light emitter groups, which are also referred to as VCSEL arrays, may be advantageously already formed as complete circular rings or circular ring segments. The configuration of individual VCSELs 320 to form other geometric shapes or groups is also conceivable so that relatively complex pumped beam profiles may, in particular, also be implemented.

Particularly efficient manufacturing processes are possible when a plurality of small, essentially rectangular, VCSEL arrays is provided (FIG. 6a) which are accordingly positioned on a shared substrate when pumped light source 30 is assembled, for example, to adapt or at least come close to the configuration according to FIG. 4a.

In another particular variant of the present invention, it is provided to dimension individual pumped light emitter groups 33a, 33b, . . . in such a way that an approximately identical power density of pumped radiation 60 results in each case in laser device 26 in the different operating modes having different beam profiles of pumped radiation 60.

The variation of the pumped energy made possible according to the present invention and thus the pulse energy of laser ignition pulses 24 is advantageously accomplished solely by the geometric and electrical configuration as well as an appropriate electrical activation and does not require any movable optical components. It is thus very fast compared to conventional systems having mechanically movable parts.

According to the present invention, it is even possible to generate multiple laser ignition pulses 24 per combustion cycle of internal combustion engine 10; laser ignition pulses 24 may also have different pulse energies when activated using pumped radiation 60 having a different beam cross section in each case. Laser-based ignition device 27 may thus advantageously adapt to different operating conditions of internal combustion engine 10 (no-load, full load).

1-13. (canceled)

14. A laser spark plug for an internal combustion engine, comprising:
a laser device, which includes a laser-active solid and a passive Q-switch; and
a pumped light source to generate pumped radiation and to irradiate it onto the laser device;
wherein the pumped light source has a plurality of individual pumped light emitters, including at least two pumped light emitters each being activatable separately from one another.

15. The laser spark plug of claim 14, wherein the pumped light emitters are situated on an essentially planarly configured heat sink

16. The laser spark plug of claim 14, wherein the pumped light emitters are situated essentially in a matrix-like manner.

17. The laser spark plug of claim 14, wherein the pumped light emitters are essentially situated along multiple virtual concentric circular ring areas.

18. The laser spark plug of claim 14, wherein the pumped light emitters are essentially situated along at least one virtual spiral line.

19. The laser spark plug of claim 17, wherein multiple pumped light emitters, which are situated on the same virtual circle or a predefinable longitudinal section of the spiral line, are connected to one another to form an emitter group whose pumped light emitters are activatable jointly via a control connection of the emitter group.

20. The laser spark plug of claim 14, wherein the individual pumped light emitters or groups of pumped light emitters are assigned microlenses to collimate the pumped radiation.

21. The laser spark plug of claim 14, wherein the pumped light emitters each have at least one or multiple semiconductor lasers of the vertical cavity surface emitting laser (VCSEL) type.

22. The laser spark plug of claim 14, wherein the pumped light source is integrated into a housing of the laser spark plug.

23. The laser spark plug of claim 22, wherein the heat sink is integrally joined to and/or designed in one piece with the housing of the laser spark plug.

24. A method for operating a laser spark plug for an internal combustion engine having a laser device, the method comprising:
generating pumped radiation and irradiating it onto the laser device, which includes a laser-active solid and a passive Q-switch, using a pumped light source, wherein the pumped light source has a plurality of individual pumped light emitters and at least two pumped light emitters are each activated separately from one another.

25. The method of claim 24, wherein the different groups of pumped light emitters are activated as a function of a pulse energy which should have a laser pulse generated by the laser device.

26. The method of claim 24, wherein the radially inner pumped light emitters are activated to generate a laser pulse having a first pulse energy, and that the radially inner and the radially outer pumped light emitters are activated to generate a laser pulse having a second pulse energy which is higher than the first pulse energy.
